(19) United States
(12) Patent Application Publication
(10) Pub. No.: US 2024/0394537 A1
(43) Pub. Date: Nov. 28, 2024

(54) SYSTEM AND METHOD FOR IMPLEMENTING NEURAL INVERSE IN AN ARTIFICIAL NEURAL NETWORK

(71) Applicant: Kumar Eswaran, Secunderabad (IN)

(72) Inventor: Kumar Eswaran, Secunderabad (IN)

(73) Assignee: Kumar Eswaran, Secunderabad (IN)

(21) Appl. No.: 18/671,446

(22) Filed: May 22, 2024

(30) Foreign Application Priority Data
May 23, 2023 (IN) 202341035667

(51) Int. Cl. G06N 3/082

(52) U.S. Cl. CPC G06N 3/082

(57) ABSTRACT

A system and method for reconstructing high-dimensional input data points from known output data points using an Artificial Neural Network (ANN) is provided. The system includes a memory to store an ANN trained to map high-dimensional input data points to lower-dimensional output data points by defining hyperplanes and establishing layer-specific transformation matrices. An input module receives known output data points for classification and identification results. The processor applies a reverse mapping process to these output data points using pseudo-inverse matrices derived from the transformation matrices, facilitating the reconstruction of high-dimensional input data points. The reconstruction engine computes intermediate data representations by applying the pseudo-inverse matrices in reverse order, reconstructing the high-dimensional input data points. This enables the ANN to perform pattern recognition and memory recall of previously learned data patterns, enhancing the system's efficiency and accuracy in handling extensive datasets.

### FIELD OF THE INVENTION

The present invention generally relates to the field of Artificial Intelligence (AI). In particular, the present invention relates to a system and method for reconstructing high-dimensional input data points from low-dimensional output data points.

### BACKGROUND OF THE INVENTION

Artificial Neural Networks (ANNs) are widely used in various applications, including image recognition, speech recognition, medical diagnostics, and autonomous systems. These networks typically rely on iterative training methods such as backpropagation to learn from data, adjusting their parameters to minimize prediction errors.

Despite the success of ANNs, their iterative training methods present several challenges and limitations. Firstly, they require substantial computational resources and processing power, making the training process time-consuming and costly. This is particularly problematic for large datasets and high-dimensional data, which are common in modern Artificial Intelligence (AI) applications.

Further, the complexity and resource-intensive nature of traditional ANN training techniques often result in slow and inefficient processing, limiting their scalability and applicability in real-time or large-scale scenarios.

Furthermore, the existing ANNs primarily focus on forward processing of data, mapping high-dimensional input data points to lower-dimensional outputs. However, there is a growing need for systems that can efficiently reverse this process, reconstructing high-dimensional input data points from known low-dimensional outputs. This capability is crucial for applications in pattern recognition, memory recall, and data compression.

Also, the black-box nature of traditional ANN models makes them less interpretable. Understanding the learned parameters and decision-making processes is challenging, which is particularly important in fields requiring transparency, such as healthcare and autonomous systems.

In view of the above limitations and challenges, there is a need for a system and method that not only provides efficient reverse mapping techniques but also addresses the computational and interpretability issues inherent in traditional ANN training methods.

### SUMMARY OF THE INVENTION

In an embodiment of the present invention, a system for reconstructing high-dimensional input data points from known output data points using an Artificial Neural Network (ANN) is provided. The system comprises a memory configured to store an ANN previously trained to map a first set of high-dimensional input data points to a first set of lower-dimensional output data points. The training of the ANN includes defining hyperplanes for the segregation of the first set of high-dimensional input data points and establishing a layer-specific transformation matrix for each layer of the ANN. In embodiments of the present invention the first set of high-dimensional input data points and the second set of known output data points are derived from one or more sources comprising digital images, sequences of video frames, audio recordings, medical imaging data, numerical data from lab tests, and environmental data from sensors on robots. Further, the training of the ANN, which includes defining the hyperplanes and establishing the layer-specific transformation matrix, is achieved by implementing a dimensionality reduction algorithm. In an embodiment of the present invention, the dimensionality reduction algorithm is KE's sieve algorithm. Also, the ANN comprises at least two layers, each layer having its own predefined set of hyperplanes and corresponding transformation matrices.

The system further comprises an input module configured to receive a second set of known output data points that correspond to at least one of: desired classification and identification results previously generated by the ANN.

A processor is also provided that is configured to apply a reverse mapping process to the second set of known output data points using pseudo-inverse matrices, each mathematically derived from a corresponding layer-specific transformation matrix of the ANN, wherein the pseudo-inverse matrices facilitate the reconstruction of a second set of corresponding high-dimensional input data points. In an embodiment of the present invention, the pseudo-inverse matrices are mathematically derived by applying Moore-Penrose inversion to the transformation matrices associated with each layer of the ANN.

The system furthermore comprises a reconstruction engine configured to compute a sequence of intermediate data representations by consecutively applying the derived pseudo-inverse matrices associated with each of the ANN's layers in a reverse order of the layers of the ANN, and to reconstruct the second set of high-dimensional input data points from the sequence of intermediate data representations. The reconstructed second set of high-dimensional input data points is determined to relate to the first set of high-dimensional input data points that generated the first set of lower-dimensional output data points during the ANN's training phase. The reconstructed second set of high-dimensional input data points also enables the ANN to perform pattern recognition and memory recall of previously learned data patterns. In an embodiment of the present invention, the reconstructed second set of high-dimensional input data points undergoes verification against a validation dataset comprising a similarly structured third set of high-dimensional input data points not previously used to train the ANN to refine the accuracy and reliability of reconstruction of the second set of high-dimensional input data points.

In another embodiment of the present invention, a method for reconstructing high-dimensional input data points from known output data points using an ANN is provided. The method comprises obtaining an ANN previously trained to map a first set of high-dimensional input data points to a first set of lower-dimensional output data points. The training of the ANN involves defining hyperplanes for the segregation of the first set of high-dimensional input data points and establishing a layer-specific transformation matrix for each layer of the ANN. In embodiments of the present invention, the first set of high-dimensional input data points and the second set of known output data points are derived from one or more sources comprising digital images, sequences of video frames, audio recordings, medical imaging data, numerical data from lab tests, and environmental data from sensors on robots. Further, the training of the ANN, which includes defining the hyperplanes and establishing the layer-specific transformation matrix, is achieved by implementing a dimensionality reduction algorithm. In an embodiment of the present invention, the dimensionality reduction algorithm is KE's sieve algorithm. Also, the ANN comprises at least two layers, each layer having its own predefined set of hyperplanes and corresponding transformation matrices.

The method further comprises receiving a second set of known output data points that correspond to at least one of: desired classification and identification results previously generated by the ANN.

The method also includes applying a reverse mapping process to the second set of known output data points by utilizing pseudo-inverse matrices, each mathematically derived from a corresponding layer-specific transformation matrix of the ANN. The pseudo-inverse matrices facilitate the reconstruction of a second set of corresponding high-dimensional input data points. In an embodiment of the present invention, the pseudo-inverse matrices are mathematically derived by applying Moore-Penrose inversion to the transformation matrices associated with each layer of the ANN.

Furthermore, the method includes computing a sequence of intermediate data representations by consecutively applying the derived pseudo-inverse matrices associated with each of the ANN's layers in a reverse order of the layers of the ANN, and reconstructing the second set of high-dimensional input data points from the sequence of intermediate data representations. The reconstructed second set of high-dimensional input data points is determined to relate to the first set of high-dimensional input data points that generated the first set of lower-dimensional output data points during the ANN's training phase. The reconstructed second set of high-dimensional input data points also enables the ANN to perform pattern recognition and memory recall of previously learned data patterns.

In an embodiment of the present invention, the reconstructed second set of high-dimensional input data points undergo verification against a validation dataset comprising a similarly structured third set of high-dimensional input data points not previously used to train the ANN. This verification process refines the accuracy and reliability of the reconstruction of the second set of high-dimensional input data points, ensuring the effectiveness and precision of the ANN in practical applications.

In yet another embodiment of the present invention, a computer program product is provided. The computer program product comprises a non-transitory computer-readable medium having computer-readable program code stored thereon. The computer-readable program code comprises instructions that, when executed by a processor, cause the processor to obtain an ANN previously trained to map a first set of high-dimensional input data points to a first set of lower-dimensional output data points. The training of the ANN involves defining hyperplanes for the segregation of the first set of high-dimensional input data points and establishing a layer-specific transformation matrix for each layer of the ANN. The computer-readable program code further comprises instructions to receive a second set of known output data points that correspond to at least one of: desired classification and identification results previously generated by the ANN.

Additionally, the computer-readable program code comprises instructions to apply a reverse mapping process to the second set of known output data points by utilizing pseudo-inverse matrices, each mathematically derived from a corresponding layer-specific transformation matrix of the ANN. The pseudo-inverse matrices facilitate the reconstruction of a second set of corresponding high-dimensional input data points. Furthermore, the computer-readable program code comprises instructions to compute a sequence of intermediate data representations by consecutively applying the derived pseudo-inverse matrices associated with each of the ANN's layers in reverse order of the layers of the ANN, and to reconstruct the second set of high-dimensional input data points from the sequence of intermediate data representations. The reconstructed second set of high-dimensional input data points is determined to relate to the first set of high-dimensional input data points that generated the first set of lower-dimensional output data points during the ANN's training phase. Additionally, the reconstructed second set of high-dimensional input data points enables the ANN to perform pattern recognition and memory recall of previously learned data patterns.

### BRIEF DESCRIPTION OF THE ACCOMPANYING DRAWINGS

The present invention is described by way of embodiments illustrated in the accompanying drawings wherein:

FIG. 1 is a block diagram illustrating a system to reconstruct high-dimensional input data points from low-dimensional output data points using an Artificial Neural Network (ANN) in accordance with an embodiment of the present invention;

FIG. 2 illustrates dimensionality reduction for a plurality of high-dimensional data points from a higher-dimension X-space to a lower-dimension S-space in accordance with an embodiment of the present invention;

FIGS. 3A and 3B illustrate an ANN architecture for the transformation from S-space to U-space and then to the final classification space, V-space, in accordance with an embodiment of the present invention; and

FIG. 4 illustrates an exemplary implementation of the neural inversion in accordance with an embodiment of the present invention;

FIG. 5 is a flowchart illustrating a method for reconstructing high-dimensional input data points from low-dimensional output data points using an Artificial Neural Network (ANN) in accordance with an embodiment of the present invention; and

FIG. 6 illustrates an exemplary computer system in which various embodiments of the present invention may be implemented.

### DETAILED DESCRIPTION OF THE INVENTION

The following disclosure is provided to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used are for the purpose of describing exemplary embodiments and should not be considered limiting. Thus, the present invention is to be accorded the widest scope encompassing numerous alternatives, modifications, and equivalents consistent with the principles and features disclosed. For clarity, details relating to technical material that is known in the technical fields related to the invention have not been described in detail so as not to unnecessarily obscure the present invention.

The present invention would now be discussed in the context of embodiments as illustrated in the accompanying drawings.

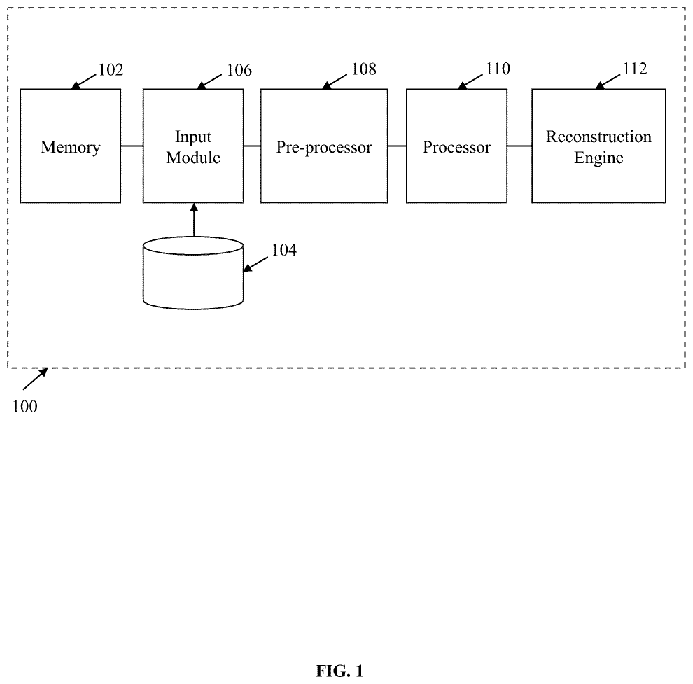

FIG. 1 is a block diagram illustrating a system 100 to reconstruct high-dimensional input data points from low-dimensional output data points using an Artificial Neural Network (ANN) in accordance with an embodiment of the present invention. The system 100 employs a reverse mapping process designed to reconstruct the original high-dimensional form of the data. This inverse processing, executed by a previously trained ANN, is implemented by employing a neural inversion technique to reconstruct high-dimensional input data points or input vectors from the low-dimensional output data points or output vectors. The system 100 comprises a memory 102, a database 104, an input module 106, a pre-processor 108, a processor 110 and a reconstruction engine 112. The memory 102 stores a previously trained ANN that facilitates the reconstruction of higher-dimension data points from the lower-dimension data points. The stored ANN may include a comprehensive detailing of the ANN's architecture or configuration which includes processing nodes across all layers of the ANN, weight matrices that have been optimized during training, and the bias terms that offset each node's activation or facilitate the ANN's operation. The stored ANN may be obtained or retrieved from the memory 102 utilizing quick and efficient retrieval techniques, ensuring that the ANN's accuracy and computational efficiency are maintained when applied to subsequent tasks.

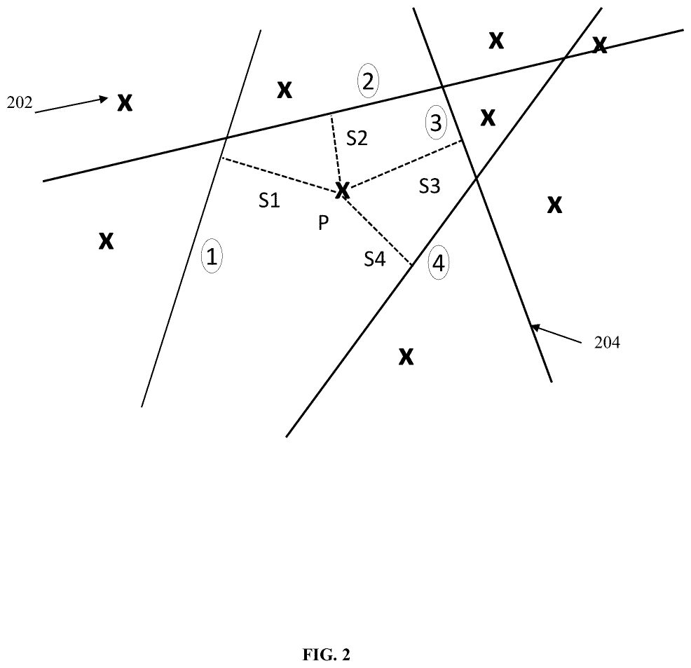

Further, the previously trained ANN has been generated in a non-iterative manner for a variety of tasks involving classification and decision-making for a plurality of applications including, but not limited to, image classification, video classification, classification and decision-making from speech data, disease classification from medical data and numerical data, and neural training of robots for specific tasks. Furthermore, the training of the ANN involved defining hyperplanes for segregation and establishing a layer-specific transformation matrix for each layer of the ANN to map a first set of high-dimensional input data points to a first set of lower-dimensional output data points. This training comprised applying a dimensionality reduction algorithm on a plurality (N) of input data points in a high-dimensional space or an ‘n-dimensional’ space where each of these N data points in n-dimensional space may be represented as x₁, x₂, x₃, . . . , xₙ. Thereafter, each of these high-dimensional (X-space) data points were segregated or separated from each other by employing a data dimensionality reduction algorithm. In an embodiment of the present invention, the dimensionality reduction algorithm employed is KE sieve algorithm. The dimensionality reduction algorithm defines a plurality of hyperplanes for the segregation of the first set of high-dimensional input data points. The number ‘q’ of hyperplanes needed for the separation of the high-dimensional input data points may be based on a logarithmic function of the number of data points (N), such that q=O(log(N)). Each layer of the ANN utilizes a specific transformation matrix established during this training phase, which translates the relational positioning of these hyperplanes into a computational model for the ANN. The plurality of hyperplanes may be represented in the form of below equation (1):

$${α}_{m , 1} {x}_{1} + {α}_{m , 2} {x}_{2} + … + {α}_{m , n} {x}_{n} + 1 = 0 \qquad ( equation 1 )$$

where m=1, 2, . . . , q. All the coefficients α_{m,j} (m=1, 2, . . . q) and (j=1, 2, . . . , n) may be determined by the dimensionality reduction algorithm. These coefficients become the weights of the q hyperplanes in the first layer and hence are determined without iterations. If any point P is chosen in the X-Space, whose coordinates are (x₁, x₂, x₃, . . . , xₙ) and if this point is substituted into the q of equation (1) above, following relationships would be obtained by equation (2):

$${α}_{m , 1} {x}_{1} + {α}_{m , 2} {x}_{2} + … + {α}_{m , n} {x}_{n} + 1 = {s}_{m} \qquad ( equation 2 )$$

where m=1, 2, . . . , q. Upon normalizing the coefficients of the hyperplanes it may be determined that sₘ is the perpendicular distance of the point P from the m^{th} hyperplane. FIG. 2 illustrates dimensionality reduction for a plurality of high-dimensional data points from a higher-dimension X-space to a lower-dimension S-space in accordance with an embodiment of the present invention. Specifically, it shows how a typical point P, denoted as 202, in n-dimensional X-space, can be mapped to q-dimensional S-space by finding the perpendicular distances of the point P from the q hyperplanes, denoted as 204. The above equations thus determine the output s₁, s₂, s₃, . . . , s_{q} of the first layer of the processing elements in S-space, when the input is x₁, x₂, x₃, . . . , xₙ in X-Space, which are the coordinates of point P.

Further, equation 2 may be written in matrix form as:

$$A {x}_{∼} = {S}_{∼} \qquad ( equation 3 )$$

where A is a q×(n+1) matrix with coefficients α_{m,j} as defined in equation (1), {tilde under (x)} and {tilde under (S)} are (n+1)-dimensional and q-dimensional column vectors, representing the right-hand side of equations (1) or (2).

Further, equation 3 may also be considered as a mapping of a point P (in X-Space) with coordinates (x₁, x₂, x₃, . . . , xₙ) to a point P′ (in S-Space) whose coordinates are (s₁, s₂, s₃, . . . , s_{q}) which are represented as outputs of the first layer of processing elements when the input is the coordinates of point P viz. (x₁, x₂, x₃, . . . , xₙ). It may be apparent to a person of skilled in the art that to obtain weights of the processing elements in further layers similar processing may be done.

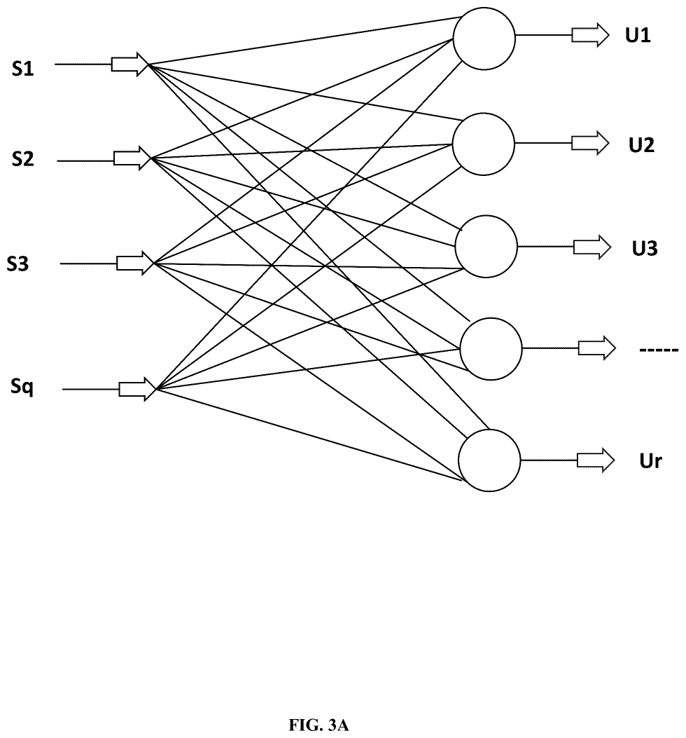

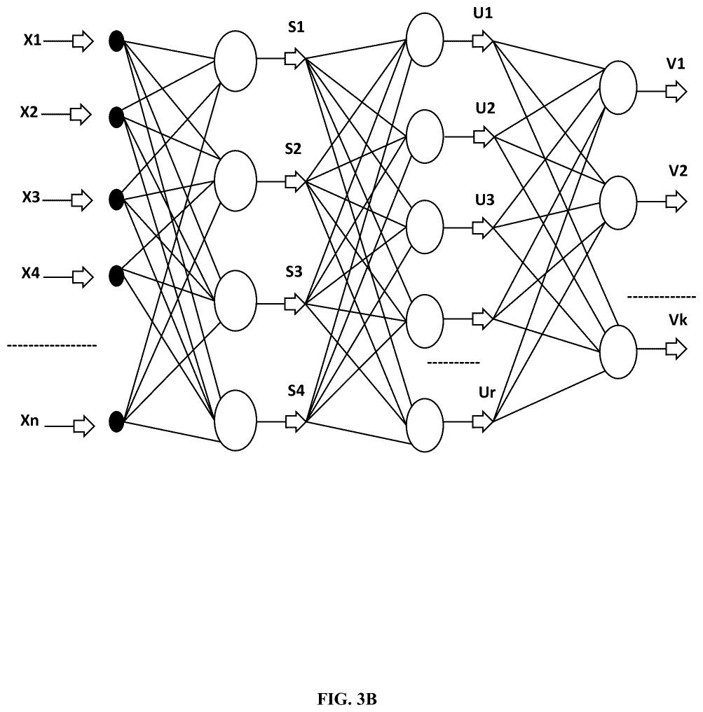

FIGS. 3A and 3B illustrate an ANN architecture for the transformation from S-space to U-space and then to the final classification space, V-space, in accordance with an embodiment of the present invention. As shown in FIGS. 3A and 3B, following the separation of inputs P in X-space by q hyperplanes, a similar mapping process is employed where all data points P′ in S-space are mapped to U-space. This transformation is facilitated through the partitioning of P′ points using r hyperplanes in the q-dimensional S-space, employing the dimensionality reduction algorithm. Each point P′ in S-space is mapped to a corresponding point P″ in U-space, represented as (s₁, s₂, . . . , s_{q})→(u₁, u₂, . . . , uᵣ), where uⱼ is the perpendicular distance of the point P′ in S-space from the j^{th} hyperplane (where j=1, 2, . . . , r). This transformation is encapsulated within an ANN architecture, with q inputs (s₁, s₂, s₃, . . . , s_{q}) and r outputs (u₁, u₂, . . . , uᵣ). The weights of the processing elements in this new layer are determined by the coefficients of the hyperplanes used in S-space, as dictated by the dimensionality reduction algorithm. Further extending this architecture, the ANN maps points P″ in r-dimensional U-space to points P′″ in k-dimensional V-space using k hyperplanes, enhancing the network's capability for detailed data classification and representation, as shown in FIGS. 3A and 3B.

The database 104 is configured to store a dataset comprising a second set of known output data points (interchangeably referred to as known data points) in lower dimension, which serve as condensed representations of original, complex data or a second set of high dimensional input data points. The known output data points embody critical features extracted during previous processing operations by the ANN, which are essential for reconstructing the corresponding high-dimensional input data points. The stored second set of known output data points are systematically organized and catalogued in the database 104 to facilitate quick and efficient retrieval during the reverse mapping process. The database 104 setup allows the input module 106 to readily access and receive these second set of known output data points. Further, the second set of known output data points may correspond to specific classification or identification results previously generated by the ANN, capturing essential details necessary for a broad range of decision-making tasks. For example, in applications like image or video classification, the output data points might include feature vectors or summary statistics that describe key visual or temporal aspects of the content. Similarly, for applications in speech recognition or medical diagnostics, these known data points could encapsulate critical frequency components or diagnostic markers that are critical for the subsequent analytical processes.

The pre-processor 108 is configured to receive the second set of known output data points from the input module 106 and prepare them for the neural inversion process. This pre-processing stage involves a series of operations to standardize, normalize, and enhance the quality of the known data points, ensuring they are in an optimal state for subsequent processing by the ANN. The pre-processor 108 performs tasks such as scaling the known data points to a common range, correcting any anomalies like missing values or outliers, and formatting the data to ensure consistency across different metrics and dimensions. By standardizing the known data points, the pre-processor 108 ensures that all the known data points are on a comparable scale, which is crucial for the accurate reconstruction of high-dimensional input data points. Normalization further refines the data by adjusting the distribution of values, making the first set of known output data points more uniform and stable for the neural inversion process. The output from the pre-processor 108 is then received by the processor 110.

The processor 110 is configured to apply a reverse mapping process to the second set of known output data points using pseudo-inverse matrices. In an embodiment of the present invention, each pseudo-inverse matrix is mathematically derived from a corresponding layer-specific transformation matrix of the ANN using the Moore-Penrose inversion technique. The pseudo-inverse matrices facilitate the reconstruction of a second set of corresponding high-dimensional input data points. Initially, the processor 110 utilizes the pseudo-inverse of the transformation matrix A from the first layer of the ANN to the known output data points. This process involves calculating the pseudo-inverse using the Moore-Penrose inversion technique, as shown in equation (4):

$${A}^{T} \cdot A {x}_{∼} = {A}^{T} {s}_{∼} \qquad ( equation 4 )$$

Given that A^{T}·A is a square matrix, its inverse can be computed, allowing the processor 110 to solve for x:

$${x}_{∼} = {[ {A}^{T} \cdot A ]}^{- 1} {A}^{T} {s}_{∼} \qquad ( equation 5 )$$

This equation (5) establishes the pseudo-inverse transformation needed to backtrack from the output vector {tilde under (s)} or the second set of known output data points to the input vector {tilde under (x)} or the second set of corresponding high-dimensional input data points. The processor 110 performs these calculations, thereby facilitating the initial step in reconstructing the second set of high-dimensional input data points.

The processor 110 then proceeds to handle the second layer of the ANN, where the mapping (s₁, s₂, . . . , s_{q})→(u₁, u₂, . . . , uᵣ)-->(s₁, s₂, . . . , s_{q})→(u₁, u₂, . . . , uᵣ) is inverted similarly. The calculation processes represented by the second layer involve another set of pseudo-inverse matrices derived from the transformation matrix B which has β_{i,j} as coefficients of the hyperplane (i=1, 2, . . . , r) and (j=1, 2, . . . , q). The relationship is given by equation (6):

$$B {s}_{∼} = {u}_{∼} \qquad ( equation 6 )$$

The processor 110 then applies the Moore-Penrose inversion to obtain the pseudo-inverse of B as provided below:

$${s}_{∼} = {[ {B}^{T} \cdot B ]}^{- 1} {B}^{T} {u}_{∼} \qquad ( equation 7 )$$

Combining equations (5) and (7), the processor 110 derives the expression for reconstructing the input vector x when given the output vector u:

$${x}_{∼} = {[ {A}^{T} \cdot A ]}^{- 1} {{A}^{T} [ {B}^{T} \cdot B ]}^{- 1} {B}^{T} {u}_{∼} \qquad ( equation 8 )$$

This equation (8) represents the neural inversion of a two-layer neural network which determines the input data point {tilde under (x)} when the output data point {tilde under (u)} is given.

The above equation (8) states the Neural Inverse when there are two layers of processing elements. If there are three layers, another mapping such as (u₁, u₂, . . . . , uᵣ)→(v₁, v₂, . . . , vₖ) involves a coefficient rectangular k×(r+1) matrix C with coefficients γᵢⱼ, (i=1, 2, . . . , k), (j=1, 2, . . . r). A similar treatment gives a relationship:

$${u}_{∼} = {[ {C}^{T} \cdot C ]}^{- 1} {C}^{T} {v}_{∼}$$

The reconstruction engine 112 is configured to compute a sequence of intermediate data representations by consecutively applying the derived pseudo-inverse matrices associated with each of the ANN's layers in reverse order. For a three-layer ANN, involving the transformation matrix C for the third layer, the relationship is given by:

$${x}_{∼} = {[ {A}^{T} \cdot A ]}^{- 1} {{A}^{T} [ {B}^{T} \cdot B ]}^{- 1} {{B}^{T} [ {C}^{T} \cdot C ]}^{- 1} {C}^{T} {v}_{∼} \qquad ( equation 9 )$$

This equation (9) provides the comprehensive neural inversion process for reconstructing high-dimensional input data points from lower-dimensional output points in a multi-layer ANN.

The reconstruction engine 112 implements the neural inversion process ensuring that each layer-specific pseudo-inverse matrix is applied in the correct sequence. This approach accurately reconstructs the second set of high-dimensional input data points. The resulting sequence of intermediate data representations is computed and utilized to reconstruct the high-dimensional input data points, wherein the reconstructed second set of high-dimensional input data points is determined to relate to the first set of high-dimensional input data points that generated the first set of lower-dimensional output data points during the ANN's training phase. This reconstruction enables the ANN to perform pattern recognition and memory recall of previously learned data patterns.

For a general m-layer neural network, the reconstruction engine 112 may employ the following generalized expression for neural inversion:

$${x}_{∼} = {[ {A}_{1}^{T} \cdot {A}_{1} ]}^{- 1} {{A}_{1}^{T} [ {A}_{2}^{T} \cdot {A}_{2} ]}^{- 1} {A}_{2}^{T} {⋯ [ {A}_{m}^{T} \cdot {A}_{m} ]}^{- 1} {A}_{m}^{T} {w}_{∼} \qquad ( equation 10 )$$

Equation (10) ensures that the inverse mapping accurately traces back through each layer of the ANN, from the final output vector or known output data points W to the original high-dimensional input vector or data points 4. In an embodiment of the present invention, the reconstructed second set of high-dimensional input data points relates to the first set of high-dimensional input data points that generated the first set of lower-dimensional output data points during the ANN's training phase. This reconstruction enables the ANN to perform pattern recognition and memory recall of previously learned data patterns.

Further, to ensure the accuracy and reliability of the reconstructed second set of high-dimensional input data points, the system employs a validation process. This process involves using a validation dataset comprising a similarly structured third set of high-dimensional input data points that were not previously used to train the ANN. The validation dataset serves as a benchmark to verify the reconstruction performance of the ANN. During this validation phase, the reconstructed second set of high-dimensional input data points is compared against the corresponding points in the validation dataset. Any discrepancies or errors identified are used to refine the reconstruction algorithms and improve the ANN's accuracy. This iterative verification process ensures that the system maintains high precision and reliability in reconstructing high-dimensional input data points, thus enabling effective pattern recognition and memory recall of previously learned data patterns.

Thus, the present invention facilitates a novel and inventive approach to employing the ANN through neural inversion for varied applications, including classification and memory recall. The neural inversion, particularly focuses on Bidirectional Associative Memory (BAM) processing, significantly enhancing the ANN's ability to recognise and recall patterns. The BAM processing has been illustrated in the following manner.

Initially, an ANN model is formulated using the dimensionality reduction algorithm. The ANN is trained using a comprehensive dataset of high-dimensional input data points, where the complete architecture with all necessary layers and the weight for each processing element are determined by employing the dimensionality reduction algorithm.

Subsequently, the Moore-Penrose technique is utilized to calculate the matrices defining the neural inversion. These calculations ensure that the neural inverse equations or expressions are fully determined. For a two-layer ANN architecture, the neural inverse equation connecting the output data points to the plausible input data points is given by Equation (8). Similarly, for a three-layer ANN, the corresponding equation is given by Equation (9). For a general multi-layer network, the neural inversion is given by Equation (10).

Further, applying the neural inversion method to BAM processing involves reconstructing the input data points that closely match the given output data points to determine their class. This is critical in recognizing and recalling similar patterns. Thus, the ANN obtained is used as a feed-forward network. Each training data point {tilde under (x)}^{(p)} is processed to obtain the corresponding output data points {tilde under (u)}^{(p)}, where p=1, 2, 3, . . . , N with N being the total number of training data points. All output data points {tilde under (u)}^{(p)} are stored in memory for efficient retrieval. Thereafter, the input data point {tilde under (x)} is then fed into the ANN to obtain the output data point {tilde under (u)}. Using a k-nearest neighbour search, the nearest data point among all data points {tilde under (u)}^{(p)} is identified, denoted as {tilde under (u)}^{(m)}. After determining the nearest data point {tilde under (u)}(m), the neural inversion process is applied to find the data point z given by Equation (8):

$${z}_{∼} = {[ {A}^{T} \cdot A ]}^{- 1} {{A}^{T} [ {B}^{T} \cdot B ]}^{- 1} {B}^{T} {{u}_{∼}}^{( m )} \qquad ( equation 11 )$$

In an embodiment of the present invention, equation (11) interprets {tilde under (z)} as the closest data point to the input data point {tilde under (x)}. In another embodiment of the present invention, instead of taking the nearest data point {tilde under (u)}^{(m)}, average data point {tilde under (u)}^{(A)} among the k-nearest neighbours may be used, generating a new data point {tilde under (z)}^{(N)} not present in the training samples. A person skilled in the art may appreciate that this technique is generative AI. Thus, the above implementation, referred to as BAM processing by using neural inversion, enables efficient recognition and recall of data.

Further, BAM is particularly useful for recognizing similar patterns. For instance, associating two different images of the same person or linking the “image” of an object to its “name”. The present invention may also act as an associative memory device, facilitating tasks such as associating the image of a telephone with the voice or the uttered word “telephone”.

By utilizing the illustrated approach as explained, the ANN's architecture may be completely determined, including the number of processing elements in each layer and all the weights of the processing elements. The neural inversion may classify extensive datasets and facilitate the easy recall of data from memory. Its non-iterative and deterministic characteristic offers an alternative to backpropagation and deep learning algorithms currently used in AI.

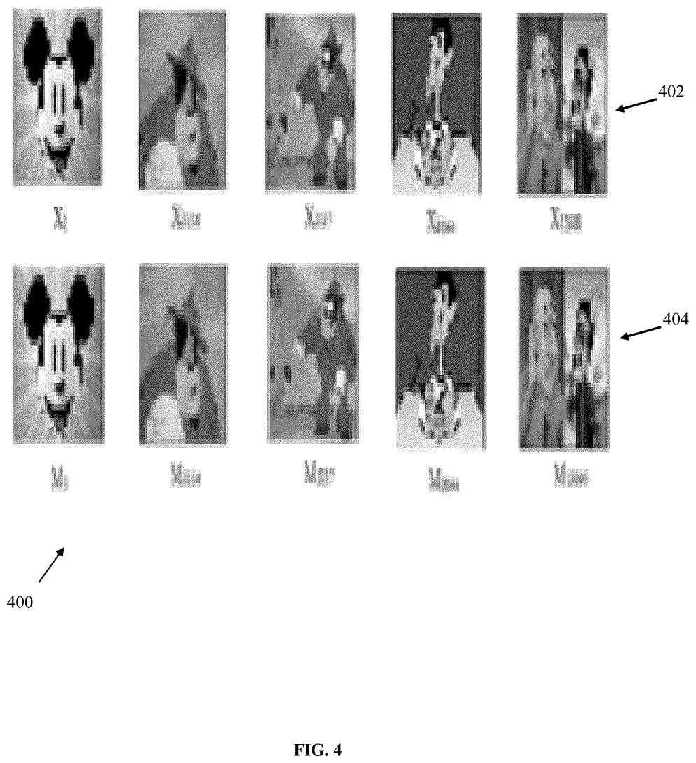

Further, FIG. 4 illustrates an exemplary implementation of the neural inversion in accordance with an embodiment of the present invention. To illustrate the application of the neural inversion of the present invention, a cartoon video dataset is used. Each frame of the original cartoon data set was a coloured (RGB) image of rectangular shape (466 pixels×360 pixels, 3 colours. Since this involved too many dimensions the image was reduced to a 30×30 rectangular image. The procedure was as follows: the image was partitioned into 900 rectangles, in a 30×30 configuration, (like a rectangular chess-board). Then the average intensity of each rectangle was obtained by averaging out all the RGB pixels lying within that rectangle, and converting the average into a single grey-scale intensity level lying between 0 to 256. Thus, every frame is represented by 900 rectangles of different intensities. In this manner, each frame is now represented by a 30×30 image or an array of 900 dimensions. Our purpose is to apply our Neural Inverse technique on such 900-dimension images and explicitly demonstrate it works. As can be seen from FIG. 4, a sample of the results of the example problem for five randomly selected test frames is illustrated. A first row 402 shows the original images, and a second row 404 shows the reconstructed images obtained by the neural inversion technique of the present invention. Before printing we have magnified the 30×30 images, because an image of 30×30 pixels is very small to the human eye. The blurring of the image is because of this magnification, actually the reconstruction judging by the actual numerical values is near perfect. Further, this dataset includes five cartoons, with the description of the dataset shown in Table 1.1. The 0th, 10th, 20th, 30th, . . . (every 10th frame or approximately ten percent of frames) frames from each cartoon video were collected, reduced to 30×30 (following the above procedure), and considered as training frames, while the remaining frames were also reduced to 30×30 and were considered as test frames. The dataset contains 14,179 training frames and 1,27,594 test frames.

Each frame image was reduced to 30×30 pixels, resulting in 900 attributes, defining the dimension of X-space. The dataset is split in the ratio of 10:90 for training and testing. All training and test data frame pixel values are normalized (values range from −1 to 1 float). The ANN model is first constructed by using the dimensionality reduction algorithm only on the training frames. The dimensionality reduction algorithm draws an adequate number of hyperplanes in X-space, S-space, and U-space. The data below shows the number of training and test frames:

TABLE 1.1

| No: | Cartoon Video | Duration | # Train Frames | # Test Frames |
|---|---|---|---|---|
| 1. | Mickey Mouse | 8 m 15 s | 1188 | 10690 |
| 2. | Tom and Jerry | 10 m 22 s | 1866 | 16792 |
| 3. | Donald Duck | 10 m 22 s | 2944 | 26480 |
| 4. | Mr Bean | 31 m 30 s | 4726 | 42529 |
| 5. | Motu Patlu | 23 m 02 s | 3455 | 31094 |
| | TOTAL | | 14,179 | 1,27,594 |

The steps followed for neural inversion using the above dataset involve initially constructing the ANN model with a total of 14, 179 training images (frames). Each of the remaining 1,27,594 frames serves as test images. The process entails performing neural inversion on these test images to retrieve the corresponding input image, subsequently examining the closeness of the retrieved image to the actual image. The close recovery of the input image demonstrates the accuracy and efficacy of neural inversion.

The dimensionality reduction algorithm employed the total number of 14,179 training points (test frames) to generate hyperplanes in X-space and S-space. The neural network architecture comprised an input layer of 900 features (x₁, x₂, x₃, . . . , xₙ) and an output layer in U-space. The detailed data is as follows in Table 1.2:

TABLE 1.2

| No. | Name | Dimension of Space | Number of Hyperplanes | |
|---|---|---|---|---|
| 1. | X-space | 900 (n) | 950 | (q) |
| 2. | S-space | 950 (q) | 1000 | (r) |

From the above deployment of the dimensionality reduction algorithm, matrices A and B were constructed, and the neural inversion is given by equation (8′) viz:

$${x}_{∼} = {[ {A}^{T} \cdot A ]}^{- 1} {{A}^{T} [ {B}^{T} \cdot B ]}^{- 1} {B}^{T} {u}_{∼} \qquad ( equation {8}^{′} )$$

The equation (8′) connects the output image u(assumed given) to the input image {tilde under (x)} calculated. One of the test images was considered as L and substituted in the above equation (8′) to calculate {tilde under (x)}. This calculated image {tilde under (x)} was compared with the expected original image and found to be very close to the original image. This exercise was done for all 1,27,594 test images, and in every case, the ‘inversed image’ was very close to the expected original image, thus proving the efficiency and efficacy of the present invention. As can be seen from FIG. 4 and the second row 404 images, the reconstruction is near perfect. Further, the original images (test frames) belong to the copyright holder. They have been used here only to illustrate the efficacy of our neural inverse technique. REFERENCE: Videol(Mickey Mouse): https://youtu.be/yH58Xv204sM, Video2(Tom and Jerry): https://www.youtube.com/watch?v=QM2-MX1Lz-A&t=0s, Video3 (Donald Duck): https://youtu.be/J61Oq922JII, Video4 (Mr Bean): https://youtu.be/EGlLMGUCUos, Video5 (Motu Patlu): https://youtu.be/ry4mm6R9tNM.

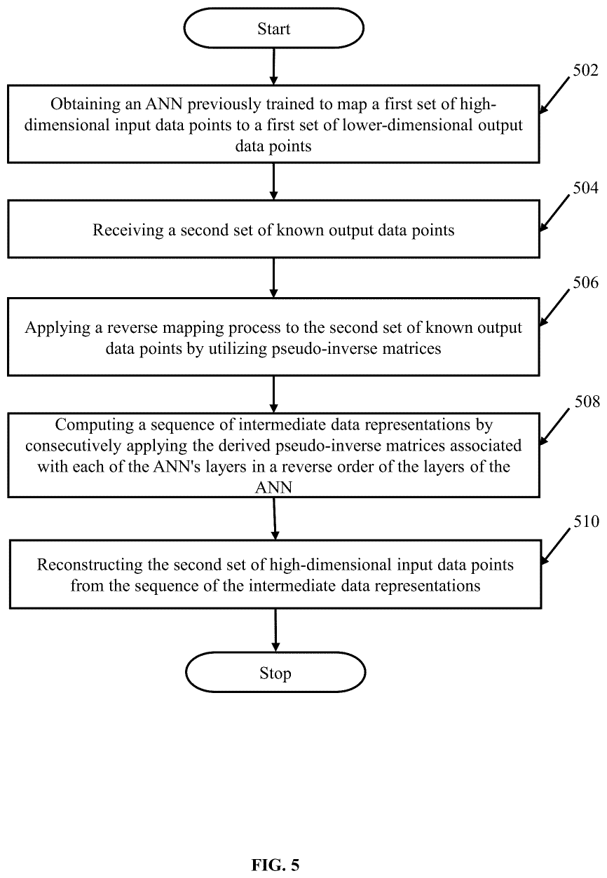

FIG. 5 is a flowchart illustrating a method 400 for reconstructing high-dimensional input data points from low-dimensional output data points using an Artificial Neural Network (ANN) in accordance with an embodiment of the present invention. The method employs a reverse mapping process designed to reconstruct the original high-dimensional form of the data, utilizing a previously trained ANN.

At step 502, a previously trained ANN obtained from a memory. The previous training of the ANN involves defining hyperplanes for the segregation of the first set of high-dimensional input data points and establishing a layer-specific transformation matrix for each layer of the ANN. The training process uses a dimensionality reduction algorithm to define a plurality of hyperplanes, represented as:

$${α}_{m , 1} {x}_{1} + {α}_{m , 2} {x}_{2} + … + {α}_{m , n} {x}_{n} + 1 = 0 \qquad ( equation 1 )$$

where m=1, 2, . . . , q. These coefficients (α_{m,j}) become the weights of the hyperplanes in the ANN's layers and are critical for determining the relationships between high-dimensional input data points and their lower-dimensional representations.

At step 504, a second set of known output data points that correspond to desired classification and identification results previously generated by the ANN are received. These known output data points are critical features extracted during the ANN's previous operations and are stored systematically in a database. The known output data points may further undergo pre-processing to ensure they are in an optimal state for subsequent processing by the ANN. This pre-processing stage involves standardizing, normalizing, and enhancing the quality of the known data points, ensuring consistency across different metrics and dimensions.

At step 506, a reverse mapping process is applied by a processor to the second set of known output data points using pseudo-inverse matrices. Each pseudo-inverse matrix is mathematically derived from a corresponding layer-specific transformation matrix of the ANN using the Moore-Penrose inversion technique. The reverse mapping process facilitates the reconstruction of a second set of corresponding high-dimensional input data points, as illustrated by:

$${A}^{T} \cdot A {x}_{∼} = {A}^{T} {s}_{∼} \qquad ( equation 4 )$$

In this equation (4), A\hat{ }T is the transpose of matrix A, s represents the known output data points, and x represents the high-dimensional input data points to be reconstructed.

Thereafter, at step 508, a sequence of intermediate data representations is computed by consecutively applying the derived pseudo-inverse matrices associated with each of the ANN's layers in reverse order. For a two-layer ANN, this process involves:

$${x}_{∼} = {[ {A}^{T} \cdot A ]}^{- 1} {{A}^{T} [ {B}^{T} \cdot B ]}^{- 1} {B}^{T} {u}_{∼} \qquad ( equation 8 )$$

where B^{T} is the transpose of matrix B, and {tilde under (u)} represents the output data points from the second layer.

For a general m-layer neural network, the reconstruction can be expressed as:

$${x}_{∼} = {[ {A}_{1}^{T} \cdot {A}_{1} ]}^{- 1} {{A}_{1}^{T} [ {A}_{2}^{T} \cdot {A}_{2} ]}^{- 1} {A}_{2}^{T} {⋯ [ {A}_{m}^{T} \cdot {A}_{m} ]}^{- 1} {A}_{m}^{T} {w}_{∼} \qquad ( equation 10 )$$

In this equation, Aᵢ^{T} represents the transpose of the transformation matrix of the i^{th} layer, and w represents the final output data points of the ANN.

At step 510, the method reconstructs the second set of high-dimensional input data points from the sequence of intermediate data representations. The reconstructed data points are related to the first set of high-dimensional input data points that generated the first set of lower-dimensional output data points during the ANN's training phase. This reconstruction enables the ANN to perform pattern recognition and memory recall of previously learned data patterns. In an embodiment of the present invention, to ensure accuracy and reliability, the reconstructed high-dimensional input data points undergo verification against a validation dataset. This dataset comprises a similarly structured third set of high-dimensional input data points that were not previously used to train the ANN. This validation process helps refine the reconstruction algorithms and improve the ANN's accuracy.

In an embodiment of the present invention, the method facilitates BAM processing, enhancing the ANN's ability to recognize and recall patterns. The ANN is used as a feed-forward network to process each training data point and store the corresponding output data points. Using a k-nearest neighbour search, the method identifies the nearest data points and applies neural inversion to determine the closest matching input data points. The same has been illustrated in equation (11):

$${z}_{∼} = {[ {A}^{T} \cdot A ]}^{- 1} {{A}^{T} [ {B}^{T} \cdot B ]}^{- 1} {B}^{T} {{u}_{∼}}^{( m )} \qquad ( equation 11 )$$

where {tilde under (z)} represents the closest matching input data points, and the terms A^{T} and B^{T} represent the transposes of matrices A and B, respectively.

By utilizing the neural inversion technique, the method enables the ANN to classify extensive datasets and facilitate the easy recall of data from memory. The non-iterative and deterministic nature of this approach offers an effective alternative to traditional backpropagation and deep learning algorithms currently used in AI.

Thus, the present invention addresses several key challenges associated with traditional ANNs and their iterative training methods by introducing a novel and inventive neural inverse algorithm. Traditional techniques like backpropagation and deep learning are computationally intensive, time-consuming, and prone to convergence issues, requiring extensive hyperparameter tuning. In contrast, the neural inverse algorithm offers a non-iterative and deterministic approach, automatically discovering the optimal neural network architecture, including the number of processing elements and their weights, based on the training data. This significantly reduces the training time and computational resources required, making the process more efficient and cost-effective.

Additionally, the neural inverse algorithm enhances the ANN's capabilities by enabling efficient reverse mapping of data. This technique reconstructs high-dimensional input data points from known low-dimensional outputs, crucial for applications such as pattern recognition, memory recall, and data compression. The method employs pseudo-inverse matrices derived from layer-specific transformation matrices to accurately backtrack from output data points to corresponding input data points, facilitating effective pattern recognition and memory recall. Furthermore, the present invention supports BAM processing, enabling the ANN to recognize and recall patterns with high accuracy and reliability. This novel and inventive approach provides a significant advancement in the field of AI, offering a faster, more efficient, and reliable alternative to traditional ANN training methods.

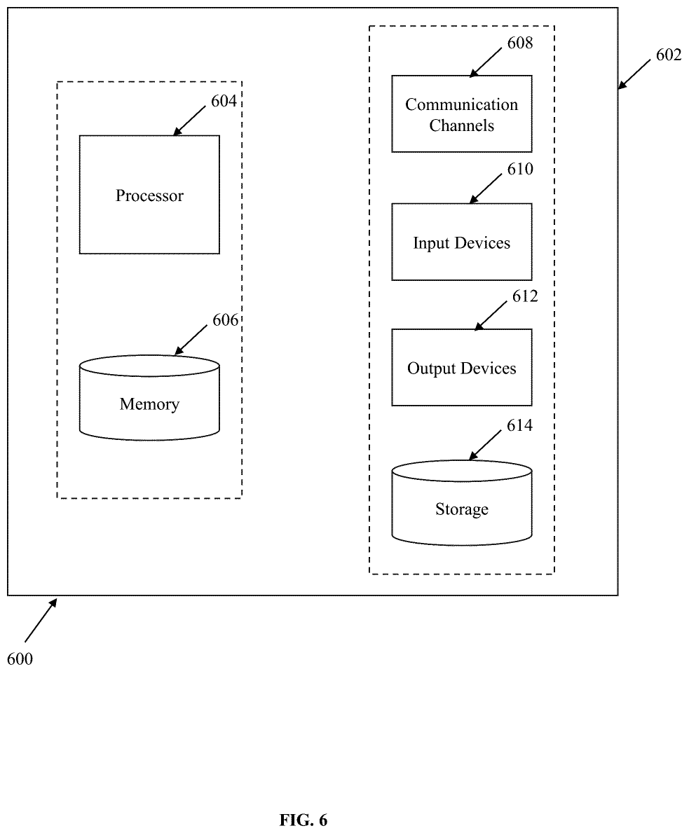

FIG. 6 illustrates an exemplary computer system 600 in which various embodiments of the present invention may be implemented. The computer system 602 comprises a processor 604 and a memory 606. The processor 604 executes program instructions and is a real processor. The computer system 602 is not intended to suggest any limitation as to scope of use or functionality of described embodiments. For example, the computer system 602 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 606 may store software for implementing various embodiments of the present invention. The computer system 602 may have additional components. For example, the computer system 602 includes one or more communication channels 608, one or more input devices 610, one or more output devices 612, and storage 614. An interconnection mechanism (not shown) such as a bus, controller, or network, interconnects the components of the computer system 602. In various embodiments of the present invention, operating system software (not shown) provides an operating environment for various software executing in the computer system 602, and manages different functionalities of the components of the computer system 602.

The communication channel(s) 608 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 610 may include, but not limited to, a keyboard, mouse, pen, joystick, trackball, a voice device, a scanning device, touch screen or any another device that is capable of providing input to the computer system 602. In an embodiment of the present invention, the input device(s) 610 may be a sound card or similar device that accepts audio input in analog or digital form. The output device(s) 612 may include, but not limited to, a user interface on CRT or LCD, printer, speaker, or any other device that provides output from the computer system 602.

The storage 614 may include, but not limited to, magnetic disks, magnetic tapes, CD-ROMs, CD-RWs, DVDs, flash drives or any other medium which can be used to store information and can be accessed by the computer system 602. In various embodiments of the present invention, the storage 614 contains program instructions for implementing the described embodiments.

The present invention may suitably be embodied as a computer program product for use with the computer system 602. The method described herein is typically implemented as a computer program product, comprising a set of program instructions which is executed by the computer system 602 or any other similar device. The set of program instructions may be a series of computer readable codes stored on a tangible medium, such as a computer readable storage medium (storage 614), for example, diskette, CD-ROM, ROM, flash drives or hard disk, or transmittable to the computer system 602, via a modem or other interface device, over either a tangible medium, including but not limited to optical or analogue communications channel(s) 608. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

I/We claim:

1. A system for reconstructing high-dimensional input data points from known output data points using an Artificial Neural Network (ANN), the system comprising:
a memory configured to store an ANN previously trained to map a first set of high-dimensional input data points to a first set of lower-dimensional output data points, wherein the training of the ANN includes defining hyperplanes for the segregation of the first set of high-dimensional input data points and establishing a layer-specific transformation matrix for each layer of the ANN;
an input module configured to receive a second set of known output data points that correspond to at least one of: desired classification and identification results previously generated by the ANN;
a processor configured to apply a reverse mapping process to the second set of known output data points using pseudo-inverse matrices, each mathematically derived from a corresponding layer-specific transformation matrix of the ANN, wherein the pseudo-inverse matrices facilitate the reconstruction of a second set of corresponding high-dimensional input data points;
a reconstruction engine configured to compute a sequence of intermediate data representations by consecutively applying the derived pseudo-inverse matrices associated with each of the ANN's layers in a reverse order of the layers of the ANN, and to reconstruct the second set of high-dimensional input data points from the sequence of intermediate data representations, wherein:
the reconstructed second set of high-dimensional input data points is determined to relate to the first set of high-dimensional input data points that generated the first set of lower-dimensional output data points during the ANN's training phase; and
the reconstructed second set of high-dimensional input data points enables the ANN to perform pattern recognition and memory recall of previously learned data patterns.

2. The system of claim 1, wherein the first set of high-dimensional input data points and the second set of known output data points are derived from one or more sources comprising: digital images, sequences of video frames, audio recordings, medical imaging data, numerical data from lab tests, and environmental data from sensors on robots.

3. The system of claim 1, wherein the training of the ANN, which includes defining the hyperplanes and establishing the layer-specific transformation matrix, is achieved by implementing a dimensionality reduction algorithm.

4. The system of claim 3, wherein the dimensionality reduction algorithm is KE's sieve algorithm.

5. The system of claim 1, wherein the ANN comprises at least two layers, each layer having its own predefined set of hyperplanes and corresponding transformation matrices.

6. The system of claim 1, wherein the pseudo-inverse matrices are mathematically derived by applying Moore-Penrose inversion to the transformation matrices associated with each layer of the ANN.

7. The system of claim 1, wherein the reconstructed second set of high-dimensional input data points undergoes verification against a validation dataset comprising a similarly structured third set of high-dimensional input data points not previously used to train the ANN to refine the accuracy and reliability of reconstruction of the second set of high-dimensional input data points.

8. A method for reconstructing high-dimensional input data points from known output data points using an Artificial Neural Network (ANN), the method comprising:
obtaining an ANN previously trained to map a first set of high-dimensional input data points to a first set of lower-dimensional output data points, wherein the training of the ANN comprised defining of hyperplanes for segregation of the first set of high-dimensional input data points and establishing a layer-specific transformation matrix for each layer of the ANN;
receiving a second set of known output data points that correspond to at least one of: desired classification and identification results previously generated by the ANN;
applying a reverse mapping process to the second set of known output data points by utilizing pseudo-inverse matrices, each mathematically derived from a corresponding layer-specific transformation matrix of the ANN, wherein the pseudo-inverse matrices facilitate the reconstruction of a second set of corresponding high-dimensional input data points;
computing a sequence of intermediate data representations by consecutively applying the derived pseudo-inverse matrices associated with each of the ANN's layers in a reverse order of the layers of the ANN;
reconstructing the second set of high-dimensional input data points from the sequence of the intermediate data representations, wherein:
the reconstructed second set of high-dimensional input data points is determined to relate to the first set of high-dimensional input data points that generated the first set of lower-dimensional output data points during the ANN's training phase, and
the reconstructed second set of high-dimensional input data points enables the ANN to perform pattern recognition and memory recall of previously learned data patterns.

9. The method of claim 8, wherein the first set of high-dimensional input data points and the second set of known output data points are derived from one or more sources comprising: digital images, sequences of video frames, audio recordings, medical imaging data, numerical data from lab tests, and environmental data from sensors on robots.

10. The method of claim 8, wherein the defining of the hyperplanes and establishing of layer-specific transformation matrix is achieved by implementing a dimensionality reduction algorithm.

11. The method of claim 10, wherein the dimensionality reduction algorithm is KE's sieve algorithm.

12. The method of claim 8, wherein the ANN comprises at least two layers, each layer having its own predefined set of hyperplanes and corresponding transformation matrices.

13. The method of claim 8, wherein the pseudo-inverse matrices are mathematically derived by applying Moore-Penrose inversion to the transformation matrices associated with each layer of the ANN.

14. The method of claim 8, wherein the reconstructed second set of high-dimensional input data points undergo verification against a validation dataset comprising a similarly structured third set of high-dimensional input data points not previously used to train the ANN to refine accuracy and reliability of reconstruction of the second set of high-dimensional input data points.

15. A computer program product comprising:
a non-transitory computer-readable medium having computer-readable program code stored thereon, the computer-readable program code comprising instructions, that when executed by a processor, cause the processor to:
obtain an ANN previously trained to map a first set of high-dimensional input data points to a first set of lower-dimensional output data points, wherein the training of the ANN comprised defining of hyperplanes for segregation of the first set of high-dimensional input data points and establishing a layer-specific transformation matrix for each layer of the ANN;
receive a second set of known output data points that correspond to at least one of: desired classification and identification results previously generated by the ANN;
apply a reverse mapping process to the second set of known output data points by utilizing pseudo-inverse matrices, each mathematically derived from a corresponding layer-specific transformation matrix of the ANN, wherein the pseudo-inverse matrices facilitate the reconstruction of a second set of corresponding high-dimensional input data points;
compute a sequence of intermediate data representations by consecutively applying the derived pseudo-inverse matrices associated with each of the ANN's layers in a reverse order of the layers of the ANN;
reconstruct the second set of high-dimensional input data points from the sequence of the intermediate data representations, wherein:
the reconstructed second set of high-dimensional input data points is determined to relate to the first set of high-dimensional input data points that generated the first set of lower-dimensional output data points during the ANN's training phase, and
the reconstructed second set of high-dimensional input data points enables the ANN to perform pattern recognition and memory recall of previously learned data patterns.
